(19) United States
(12) Patent Application Publication
(10) Pub. No.: US 2026/0187976 A1
(43) Pub. Date: Jul. 2, 2026

(54) METHOD FOR ESTABLISHING AT LEAST ONE CELL CLUSTER OF CELLS IN A GRID OF A PLURALITY OF SUCH CELLS

(71) Applicants: Robert Bosch GmbH, Stuttgart (DE); CARIAD SE, Wolfsburg (DE)

(72) Inventors: Ana-Maria Franzen-Brecan, Stuttgart (DE); Diego Gil Vazquez, Sindelfingen (DE)

(21) Appl. No.: 19/433,688

(22) Filed: Dec. 26, 2025

(30) Foreign Application Priority Data
Dec. 27, 2024 (DE) 10 2024 139 780.2

(51) Int. Cl. G06V 10/762; B60W 60/00; G01S 13/86; G01S 13/931; G06V 10/764; G06V 20/58

(52) U.S. Cl. CPC G06V 10/762; B60W 60/001; G01S 13/867; G01S 13/931; G06V 10/764; G06V 20/58; B60W 2420/403

(57) ABSTRACT

A method for establishing cell clusters in a grid of a plurality of cells for receiving cell contents may include, dependent on the cell contents contained in the plurality of cells, forming at least one cell cluster out of at least two cells of the plurality of cells. The method may further include updating a completed establishment of cell clusters only locally in a region by at least one cell for which updated cell contents are present.

### CROSS-REFERENCE TO RELATED APPLICATIONS

This application claims priority to German Patent Application No. DE 10 2024 139 780.2, filed on Dec. 27, 2024, the contents of which is hereby incorporated by reference in its entirety.

### TECHNICAL FIELD

The present invention relates to a method for establishing at least one cell cluster in a grid of a plurality of cells. The invention, further, relates to a control device which is equipped/programmed for carrying out this method. In addition, the invention relates to a motor vehicle having such a control device. Finally, the invention relates to a computer programme product and to a data carrier, each for carrying out the method.

### BACKGROUND

Individual cells of an image of the external environment of a motor vehicle are often combined into cell clusters for more efficient further processing.

With conventional methods for forming cell clusters, the establishment of cell clusters in the presence of new cell contents is typically newly carried out for the entire grid. In practice, this proves to be processor-intensive, which, however, proves to be problematic since in a motor vehicle only limited processing power is generally available.

### SUMMARY

It is therefore an object of the present invention to create an improved embodiment for a method for establishing cell clusters in a grid of such cells introduced at the outset, with which the abovementioned disadvantages are at least partly eliminated.

This object is achieved through the subject matter of the independent patent claim(s). Preferred embodiments are the subject matter of the dependent claim(s).

Accordingly, the basic idea of the invention is to update the establishment of cell clusters in a grid of cells with cell contents in the presence of new, i.e. changed cell contents for one or more cells, not for the entire grid, i.e. for all cells of the grid, but only locally in a region of a cell for which changed cell contents are present. Thus, cell clusters, once established, develop further over the course of time.

Since with the method according to the invention the entire grid with all cells does not have to be utilised, the required processing time for updating existing cell clusters is dependent only on the quantity of changed cell contents and not on the size of the entire grid. This results in a substantial reduction of the processing time required for updating the cluster establishment.

Following the above inventive idea, the method according to the invention introduced here serves for establishing cell clusters in a grid of a plurality of cells. For carrying out the method, cells of the grid can contain cell contents. Here, cell contents is to mean, in particular, environmental information which was created by a sensor—this can be, in particular, a camera for image generation or for generating video sequences, but also a radar sensor. Dependent on the cell contents contained in these cells, at least one cell cluster of at least two cells can be formed from different cells. According to the invention, an establishment of the cell clusters already performed and thus existing is thus updated only locally in a region by a respective cell, regarding which new cell contents are available.

In a preferred embodiment, the cell contents can be, or include environmental information which was created by at least one sensor device monitoring an environment, in particular, a front of a motor vehicle, in particular, by a camera or by a radar sensor.

Particularly preferably, the establishment of the cell clusters takes place so that only cells, whose cell contents fulfil a predetermined cluster criterion, are combined into a cell cluster.

Particularly preferably, such a cluster criterion can be considered fulfilled when the cell contents of the cells to be clustered are identical. Alternatively to this, however, the cluster criterion can also be considered fulfilled when the cell contents of each of the cells to be clustered is greater than a predetermined threshold value.

According to an advantageous further development, the cells can be formed layer-like and comprise a first cell layer with first cell contents which are assigned to a first content category, and at least one second cell layer with second cell contents, which are assigned to a second content category.

Preferably, the content category can include or be:
an object classification of the relevant cell;
a height of the relevant cell above the road;
a probability that the motor vehicle can collide with the relevant cell.

Particularly preferably, the cell contents of at least two cell layers can have been created by different sensor devices.

Particularly practically, an individual cluster criterion—in the following defined as “I-cluster criterion”—can have been established for each content category. With this variant, the cluster criterion relevant for forming clusters is then established, dependent on the at least two I-cluster criteria.

Particularly preferably, the I-cluster criterion-analogously to the cluster criterion—can also be considered fulfilled when the cell contents of the relevant cell layer of the cells to be clustered are identical. This can be, in particular, practical when the content category is, for example, an object classification of the respective cell. Then, cells which belong to the same object class—for example, a road boundary or a traffic sign—can be clustered.

Alternatively to this, the I-cluster criterion—likewise analogously to the cluster criterion—can be considered fulfilled when each of the cell contents of the relevant cell layer of the cells to be clustered is greater than a predetermined threshold value.

In a preferred embodiment, the region of the grid to be updated or already updated includes all eight-neighbours of the cell(s), for which changed cell contents are present, and any cell clusters, to which the respective eight-neighbour belongs. In this way, the process of updating the cluster establishment can be substantially accelerated, since in practice only a fraction of all existing cells has to be checked with respect to an update of the cluster establishment.

With a further preferred embodiment of the method according to the invention, each formed cell cluster and each cell belonging to each relevant cell cluster is assigned a unique cluster identifier. This facilitates the further processing of the cell contents or image information contained in the respective cell cluster.

In a preferred embodiment, the establishment of the cell clusters takes place so that each cell of a respective cell cluster forms at least one eight-neighbour of another cell of the same cell cluster.

According to an advantageous further development of the method, an existing cell cluster can be expanded by a cell when for this cell new cell contents are present and when the cluster criterion is fulfilled and when this cell is an eight-neighbour of the existing cell cluster.

According to an advantageous further development, two existing cell clusters are fused into a single cell cluster when a certain cell with changed state forms an eight-neighbour of these two cell clusters, wherein the fused cell cluster also includes the cell with the changed state. Thus, with a suitable change of the state of the cell, two different cell clusters can be efficiently combined into a single cell cluster.

Particularly preferably, two separate cell clusters can be formed out of exactly one existing cell cluster when cell contents of a cell of the existing cell cluster are deleted, wherein only this one cell forms a common eight-neighbour of the two separate cell clusters.

Further, the invention relates to a control device which is equipped/programmed for carrying out the method according to the invention introduced above. The advantages of the method according to the invention introduced above, therefore, apply also to the control device according to the invention.

The invention also relates to a motor vehicle, includes at least one camera for generating images of an environment, in particular, of a front of the motor vehicle. The motor vehicle according to the invention additionally includes a control device according to the invention introduced above, which for the transmission of camera data is connected to the at least one camera in a data-transmitting manner. The advantages of the method according to the invention introduced above consequently apply also to the motor vehicle according to the invention, wherein the motor vehicle forms the ego-vehicle in carrying out the method according to the invention.

Furthermore, the invention relates to a computer programme product which receives commands which, upon the execution of the computer programme product by a computer system and/or by a control device according to the invention introduced above, prompt the same to carry out the method according to the invention. The advantages of the method according to the invention introduced above consequently apply also to the computer programme product according to the invention.

Furthermore, the invention relates to a data carrier which contains commands, which, during the execution by a computer system or by a control device according to the invention, prompt the same to carry out the method according to the invention. The advantages of the method according to the invention introduced above consequently apply also to the data carrier according to the invention.

Further important features and advantages of the invention are obtained from the subclaims, from the drawings and from the associated figure description by way of the drawings.

It is to be understood that the features mentioned above and still to be explained in the following cannot only be used in the respective combinations stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically:

FIG. 1, in a plan view, shows an example of a motor vehicle according to the invention travelling on a road,

FIG. 2a exemplarily shows an image of the front of the ego-vehicle generated by means of a radar sensor,

FIG. 2b shows a schematic representation which illustrates a layer-like formation of a grid of multiple cells,

FIG. 3 exemplarily shows a grid with a plurality of cells and with multiple cell clusters formed out of individual cells,

FIG. 4 shows a representation of an individual cell cluster illustrating the definition of eight-neighbours,

FIG. 5 exemplarily shows the structure of an individual cell cluster with cells formed out of eight-neighbours,

FIGS. 6a through 9b show various examples which illustrate the fusion and the separation of cell clusters with the help of the method according to the invention.

### DETAILED DESCRIPTION

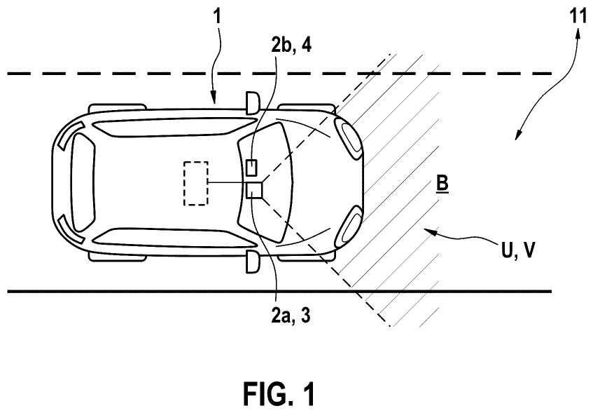

FIG. 1 shows in a plan view an example of a motor vehicle 1 according to the invention travelling on a road 11. The motor vehicle 1 includes two sensor devices 2a, 2b for monitoring an environment U in the exemplary scenario of a front V of the motor vehicle 1.

A first sensor device 2a is a camera 3 for generating images B of the environment U or of the front V of the motor vehicle 1. A second sensor device 2b is a radar sensor 4, with which objects (not shown) present in the front (V), or in the environment U can be detected. Furthermore, the motor vehicle 1 includes a control device 5, which for receiving sensor data from the two sensor devices 2a, 2b is connected to these in a data-transmitting manner. The control device 5 is equipped and programmed for carrying out the method according to the invention, which will still be exemplarily explained in the following.

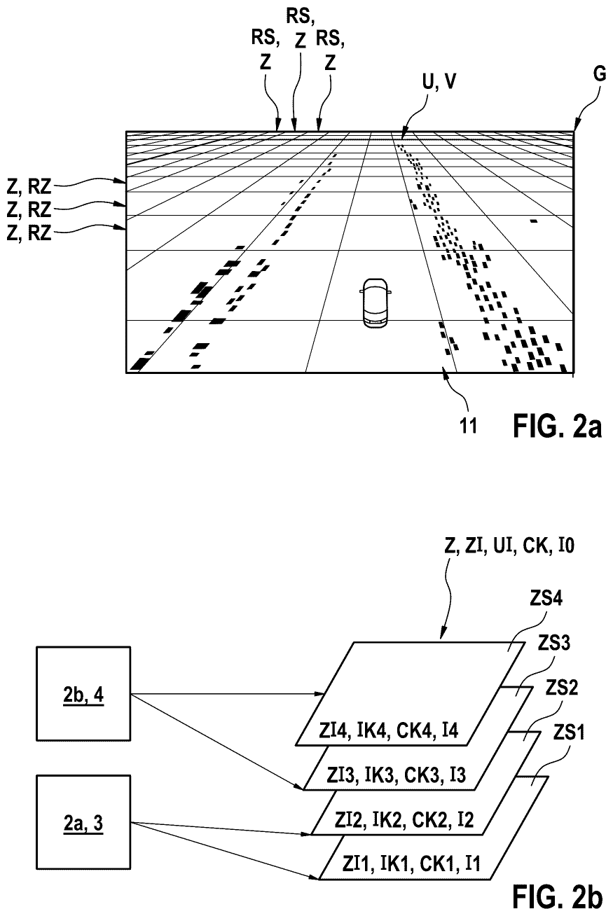

FIG. 2 a shows exemplarily a grid G of the front V, or environment U of the motor vehicle 1, or of the road 11 generated with the help of the radar sensor 4.

The grid G is formed by a plurality of cells Z, which are arranged grid-like. The grid G, thus, includes a plurality of grid lines RZ and grid columns RS of cells Z.

According to the schematic representation of FIG. 2 b, the cells Z of the grid G can each

be formed layer-like and in the example include a first, second, third and fourth cell layer ZS1-ZS4.

The first cell layer ZS1 includes first cell contents ZI1, which are assigned to a first content

category IK1. The second cell layer ZS2 includes second cell contents ZI, ZI2, which are assigned to a second content category IK2. The third cell layer ZS1 includes third cell contents ZI4, which are assigned to a third content category IK3. The fourth cell layer ZS4, in turn, includes fourth cell contents ZI4, which are assigned to a fourth content category IK4.

The cell contents ZI1-ZI4 present in the cells Z are environmental information relating to

the current environment U, or the current front V of the motor vehicle 1 travelling on the road 11, which were generated by means of the two sensor devices 2a, 2b, i.e. with the help of the radar sensor 4 and with the help of the camera 3. Concretely, the first and second cell contents ZI1 and ZI2 were generated in the exemplary scenario by the camera 3, the third and fourth cell contents ZI4 and ZI4 by contrast by the radar sensor 4. The cell contents ZI1-ZI4 can thus be generated by different sensor devices 2a, 2b.

In the example, the first content category is an object category of the relevant cell. The

second content category reflects a probability that the motor vehicle can collide with the relevant cell. The third content category K reflects a height estimate of the relevant cell above the road. The fourth content category, in turn, is a probability that the motor vehicle can collide with the relevant cell.

With the method according to the invention, the establishment of the cell clusters C1-C11

substantial to the invention takes place so that only cells Z, the cell contents ZI1-ZI4 of which fulfil a predetermined cluster criterion CK are combined into a cell cluster C1-C11. In the example, an individual I-cluster criterion ICK1-ICK4 is established for each of the four content categories IK1-IK4. The resulting cluster criterion CK, i.e. the decision as to whether the relevant cells are going to be clustered, will be established dependent on the different I-cluster criteria ICK1-ICK4.

The cluster criterion CK, or an individual cluster criterion CK-1 to CK-4 can be considered fulfilled when the cell contents ZI, ZI1-ZI4 of the relevant cells Z are identical. Alternatively to this, the cluster criterion CK, or the individual cluster criteria CK-1 to CK-4 can each be considered fulfilled when each of the cell contents ZI, ZI1-ZI4 of the relevant cells Z is greater than a predetermined threshold value I0 or I1-I4.

Analogously to the cluster criterion CK, a respective I-cluster criterion ICK1-ICK4 can particularly preferably also be considered fulfilled when each of the relevant cell contents ZI, ZI1-ZI4 of the cell layer ZS1-ZS4 of the cells Z to be clustered are identical. Alternatively to this, a respective I-cluster criterion ICK1-ICK4 can be considered fulfilled—likewise analogously to the cluster criterion CK—when each of the relevant cell contents ZI1-ZI4 of the cell layer of the cells Z to be clustered is greater than a predetermined threshold value.

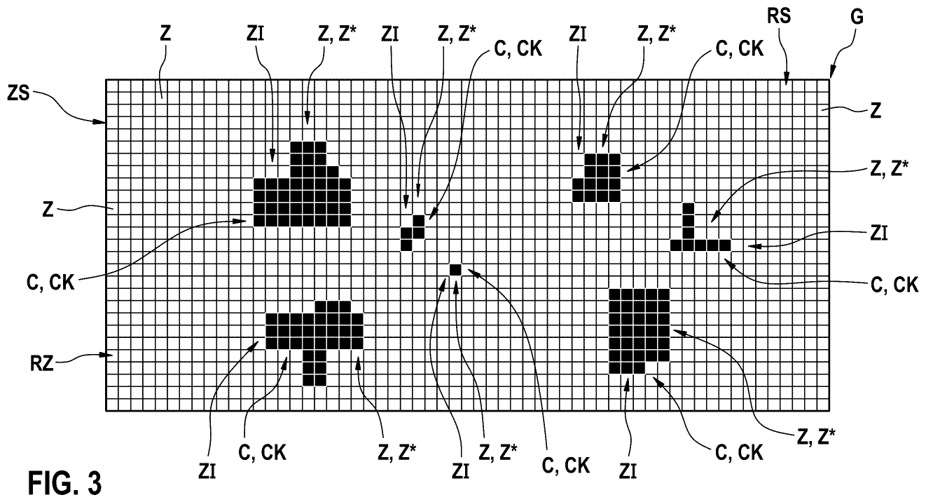

FIG. 3 shows a part region of the grid G in greatly simplified representation. Here, a cell Z is shown for the sake of clarity, which consists only of a single cell layer ZS.

Prior to carrying out the method-still to be exemplarily explained-each cell Z can be in a state occupied by cell content ZI, i.e. comprise cell contents ZI, or be in an unoccupied state, i.e. does not comprise any cell content ZI.

In the example of FIG. 3, exactly those cells Z which are in an occupied state, are shown filled out with black colour and are additionally designated with Z*. With the help of the method according to the invention, cell clusters C exemplarily shown dependent on the cell contents in FIG. 3 are formed out of those cells Z* which are in the state occupied by cell contents ZI.

In FIG. 3, multiple such cell clusters C are exemplarily shown. Each cell cluster C can be assigned a unique cluster identifier.

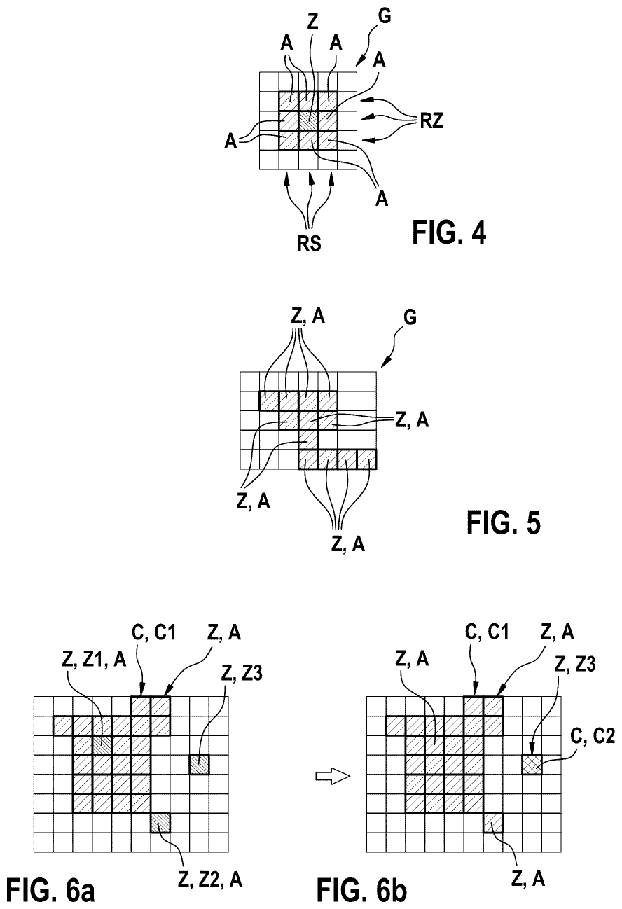

By way of FIG. 4, the term “eight-neighbour” is explained in the following. As illustrated in FIG. 4, eight-neighbours A of a certain cell Z in the grid G formed out of grid lines RZ and grid columns RS are to mean those cells which:
a) are arranged in the same grid line RZ as the cell Z and in a grid column RS adjacent to the cell Z; or
b) are arranged in the same grid column RS as the cell Z and in the grid line RZ adjacent to the cell Z; or
c) are arranged in a grid column RS adjacent to the cell and additionally in a grid line RZ adjacent to the cell Z.

FIG. 5 shows exemplarily the structure of a single cell cluster C with cells Z formed out of eight-neighbours A in the grid G. Accordingly, those cells Z form the cell cluster C, which are occupied by cell contents. Here, each individual cell Z of the cell cluster C forms at least one eight-neighbour A of another cell Z of the same cell cluster C.

In the example of FIG. 5, the shown cell cluster C is formed by twelve cells Z, wherein each of the twelve cells Z is an eight-neighbour A of at least one further cell Z.

The FIG. 3 already explained above shows exemplarily a snapshot of the grid G. With conventional methods, the establishment of all cell clusters C can be updated cyclically or in the presence of new cell contents for at least one cell Z. The grid G of cells Z can be considered as “rolling” grid, which follows a movement of the sensor generating the cell contents—preferably of a camera 1 generating an image. With the method according to the invention, by contrast, updating of the grid only takes place locally in a region updated by one respective cell, for which changed cell contents are present.

This is exemplarily illustrated by way of the representation of FIGS. 6a and 6b. In FIG. 6a an existing cell cluster C with the cluster identifier “C1” of cells Z is shown. In the example of FIG. 6a, new cell contents are present for three cells Z1, Z2, Z3. The two cells Z1, Z2 are eight-neighbours A of at least one cell Z of the existing cell cluster C1. The cell Z3, by contrast, is not such an eight-neighbour of the cells Z of the cell cluster C1. Consequently, the two cells Z1 and Z2, as shown in FIG. 6 b, are assigned to the cell cluster C with the cluster identifier “C1”, i.e. the updated cell cluster with the cluster identifier “C1” also contains the two cells Z1 and Z2. A cell cluster C with the ID “C2” distinct from the cell cluster with the ID “C1” is formed out of the remaining cell Z3. The cell cluster C with the ID “C2” is formed by a single cell Z, the said cell Z3. As shown above, an existing cell cluster C1 can be expanded by cells Z1, Z2 when these have transitioned from the unoccupied state into the state occupied by cell content, and when each of these cells Z1, Z2 with changed state is an eight-neighbour A of the existing cell cluster C1. By contrast, a new cell cluster C2 is formed only when a certain cell Z—in the example of the FIGS. 6a, 6b the cell Z3—as changed from the unoccupied state into the state occupied by cell contents and when this cell Z3 is not an eight-neighbour A of an already existing cell cluster.

From the above explanations to the FIGS. 6a and 6b it additionally follows that with the method according to the invention, the region of the grid G to be updated or already updated includes all eight-neighbours A of the cells Z, in the example, thus, the cells Z1, Z2, Z3 for which changed cell contents are present, and any cell clusters to which the respective eight-neighbour A belongs.

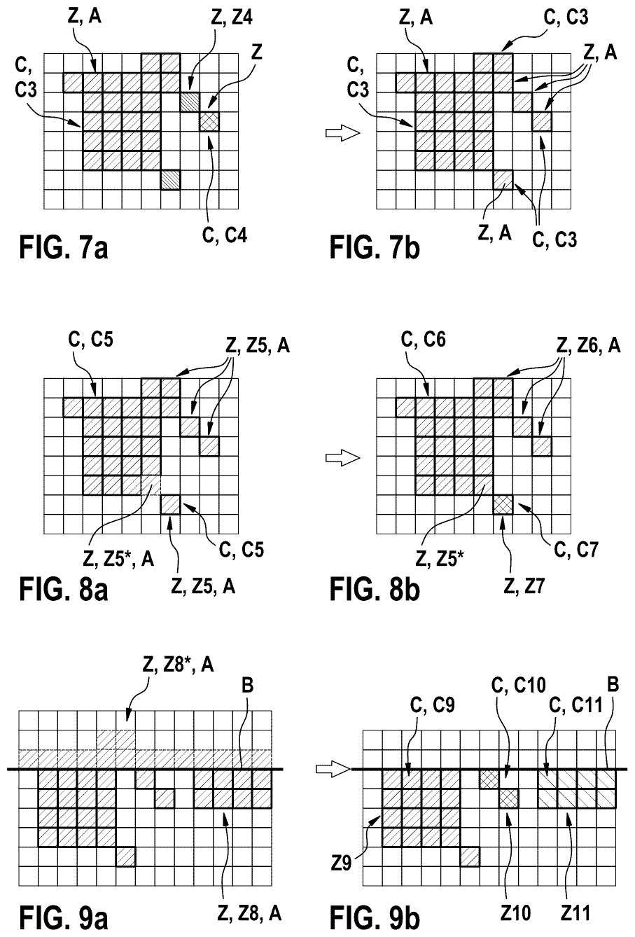

By way of the FIGS. 7 a and 7 b, the fusion of two separate cell clusters C with different cluster identifiers “C3” and “C4” into a single cell cluster C3 is explained in the following. As is evident from the representation of FIG. 7a, the two existing cell clusters with cluster identifier “C3” and cluster identifier “C4” are fused into a single cell cluster with cluster identifier “C3”, when a certain cell Z4 with changed cell content represents an eight-neighbour A of these two cell clusters “C3” and “C4”. During the course of this cluster fusion, this cell Z4 is added to the fused cell cluster “C3”. This scenario is shown in FIG. 7b.

By way of the FIGS. 8 a and 8 b, the separation of a single cell cluster C with cluster identifier C5 into two separate cell clusters C with different cluster identifiers C6 and C7 is explained in the following. In the example of FIG. 8A, two separate cell clusters C6, C7 are formed out of the cells Z5, Z of the existing cell cluster C5 because the cell Z designated Z5* of the existing cell cluster C5 as shown in FIG. 8B, has transitioned into an unoccupied state. Thus, the single cell Z7, Z of the newly formed cell cluster C with the cluster identifier C7 is not an eight-neighbour A of the cells Z, Z6 of the likewise newly formed cell cluster C, C6 with the cell cluster identifier C6. Conversely, the cells Z, Z6 of the newly formed cell cluster C, C6 are no eight-neighbours A of the cell Z7 of the newly formed cell cluster C, C7.

Building on the example of FIGS. 8, 8b, the FIGS. 9a and 9b show the separation of a single cell cluster C with cluster identifier C3 into three separate cell clusters C9, C9, C10. This separation is triggered by the movement of individual cells Z8* of the cell cluster C8 beyond a grid limitation B so that these cells, as in FIG. 9b no longer form part of the grid G.

Thus, the only cell Z7, Z of the newly formed cell cluster C with the cluster identifier C7 is not an eight-neighbour A of the cells Z, Z6 of the likewise newly formed cell cluster C, C6 with the cell cluster identifier C6.

Conversely, the cells Z, Z6 of the newly formed cell cluster C, C6 are no eight-neighbours A of the cell Z7 of the newly formed cell cluster C, C7. The cells Z8 of the newly formed cell cluster C8 are no eight-neighbours A of the cells C9 of the newly formed cell cluster C9, and also no eight-neighbours A of the cells Z10 of the newly formed cell cluster C10. The cells Z9 of the newly formed cell cluster C9 are no eight-neighbours A of the cells Z8 of the newly formed cell cluster C8, and also no eight-neighbours A of the cells Z10 of the newly formed cell cluster C10. The cells Z10 of the newly formed cell cluster C10 are no eight-neighbours A of the cells Z8 of the newly formed cell cluster C8, and also no eight-neighbours A of the cells Z9 of the newly formed cell cluster C9.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,”“various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A method for establishing cell clusters in a grid of a plurality of cells for receiving cell contents, the method comprising:
dependent on the cell contents contained in the plurality of cells, forming at least one cell cluster out of at least two cells of the plurality of cells; and
updating a completed establishment of cell clusters only locally in a region by at least one cell for which updated cell contents are present.

2. The method according to claim 1, wherein the cell contents include environmental information provided via at least one sensor monitoring an environment.

3. The method according to claim 1, wherein forming the at least one cell cluster includes only combining a subset of cells of the plurality of cells, the cell contents of which fulfil a predetermined cluster criterion, into a cell cluster.

3. The method according to claim 3, further comprising considering the predetermined cluster criterion to be fulfilled when the cell contents of the subset of cells are identical.

5. The method according to claim 3, further comprising considering the predetermined cluster criterion to be fulfilled when each of the cell contents of the subset of cells is greater than a predetermined threshold value.

6. The method according to claim 1, wherein at least one cell of the plurality of cells is formed layer-like and includes a first cell layer with first cell contents, which are assigned to a first content category, and at least one second cell layer with second cell contents, which are assigned to a second content category.

7. The method according to claim 6, wherein the first content category and/or the second content category includes:
an object category of the respective cell;
a height of the relevant cell above a road; and
a probability that a motor vehicle can collide with the respective cell.

8. The method according to claim 6, wherein the first cell contents and the second cell contents are provided via different sensors.

9. The method according to claim 6, wherein:
forming the at least one cell cluster includes only combining a subset of cells of the plurality of cells, the cell contents of which fulfil a cluster criterion, into a cell cluster;
for each content category, including the first content category and the second content category, an individual I-cluster criterion is established; and
the cluster criterion is established dependent on at least two I-cluster criteria.

10. The method according to claim 1, wherein the region of the completed establishment of cell clusters to be updated includes all eight-neighbours of the at least one cell for which updated cell contents are present.

11. The method according to claim 1, further comprising assigning each formed cell cluster and each cell belonging to the respective cell cluster a unique cluster identifier.

12. The method according to claim 1, wherein the at least one cell cluster is formed such that each cell of the at least one cell cluster forms at least one eight-neighbour of another cell of the same cell cluster.

13. The method according to claim 1, wherein updating the completed establishment of cell clusters includes expanding an existing cell cluster of the completed establishment of cell clusters by a cell when:
new cell contents are present for the cell;
a cluster criterion is fulfilled by the cell contents of the cell; and
the cell is an eight-neighbour of the existing cell cluster.

14. The method according to claim 1, wherein updating the completed establishment of cell clusters includes:
fusing two existing cell clusters of the completed establishment of cell clusters into a single fused cell cluster when, for a certain cell containing no cell contents, new cell contents are provided for the certain cell and the certain cell forms an eight-neighbour of each of the two existing cell clusters; and
assigning the certain cell to the fused cell cluster.

15. The method according to claim 1, wherein updating the completed establishment of cell clusters includes forming two separate cell clusters out of an existing cell cluster of the completed establishment of cell clusters when the cell contents are deleted from a cell of the existing cell cluster and the cell is the only cell forming a common eight-neighbour of the two separate cell clusters.

16. A control device equipped and/or programmed for carrying out the method according to claim 1.

17. A motor vehicle, comprising:
at least one camera for providing images of an environment;
a control device connected to the at least one camera for transmitting camera data in a data-transmitting manner according to claim 11; and
wherein the motor vehicle forms an ego-vehicle for the method.

18. A computer programme product, comprising a plurality of commands, which upon execution of the computer programme product by a computer system and/or by a control device, prompt the computer system and/or the control device to carry out the method according to claim 1.

19. A data carrier, comprising a plurality of commands, which during execution by a computer system and/or by a control device, prompt the computer system and/or the control device to carry out the method according to claim 1.

20. The method according to claim 2, wherein:
the at least one sensor includes a camera and/or a radar sensor; and
the environment is an area disposed in front of a motor vehicle.
